(19) United States
(12) Patent Application Publication
(10) Pub. No.: US 2026/0261688 A1
(43) Pub. Date: Sep. 3, 2026

(54) METHOD AND SYSTEM FOR DUAL-DECODER FRAME-SYNCHRONIZED TRANSPARENCY DECODING

(71) Applicant: Flying Flamingos India Private Limited, Bangalore (IN)

(72) Inventors: Amit Gaiki, Bangalore (IN); Shourya Agarwal, Ajmer (IN); Shubham Shukla, Bengaluru (IN)

(73) Assignee: Flying Flamingos India Private Limited, Bangalore (IN)

(21) Appl. No.: 19/539,459

(22) Filed: Feb. 13, 2026

(30) Foreign Application Priority Data
Feb. 13, 2025 (IN) 202541012144

(51) Int. Cl. H04N 19/186; G06T 1/20; G06T 5/50; G06T 15/80; G06T 19/00; H04N 19/436

(52) U.S. Cl. CPC H04N 19/186; G06T 1/20; G06T 5/50; G06T 15/80; G06T 19/006; H04N 19/436; G06T 2207/20221

(57) ABSTRACT

The present disclosure relates to a method, system and non-transitory computer-readable medium storing instructions that, when executed by one or more processors, cause the system to perform a method for decoding and synchronizing alpha channel information from dual video streams on a communication device. The system is configured to receive a first video stream containing RGB data and a second video stream containing grayscale mask data. A first decoder processes the RGB data to obtain base frame information. A second decoder processes the grayscale mask data to obtain corresponding alpha channel values. A synchronization module aligns the decoded RGB and alpha frames based on presentation timestamps. A shader module composites the synchronized RGB data and alpha data to generate a blended RGBA output, and a display module renders the blended frames on the communication device in real time. The system enables real-time transparency rendering for applications in augmented reality, mixed reality, and immersive video visualization environments.

### CROSS-REFERENCE TO RELATED APPLICATIONS

The present application claims the benefit of Indian Provisional Patent Application No. 202541012144, filed Feb. 13, 2025, all of which are hereby incorporated by reference in their entirety for all purposes.

### TECHNICAL FIELD

The present disclosure relates generally to the field of digital video processing and rendering. More particularly, the present disclosure relates to a method and system for decoding and synchronizing alpha channel information from dual video streams.

### BACKGROUND

Many mobile and augmented-reality devices lack hardware support for decoding RGBA streams. Developers often resort to software shaders or stitched composite methods that compromise video resolution or visual quality. The single decoder stitched technique, though efficient, inherently halves the spatial resolution because both color and alpha data share the same frame area. In applications demanding high-resolution overlays—such as holographic projection, mixed-reality object compositing, or background-free video inserts, this limitation is unacceptable.

There is therefore a need for a framework that allows full-resolution decoding of color and transparency streams while maintaining precise frame-level synchronization between them. The present disclosure addresses this requirement by implementing a dual-decoder synchronization and frame-merging technique.

### SUMMARY

In an aspect, a system is disclosed. The system is configured to decode and synchronize alpha channel information from dual video streams on a communication device. The system includes a receiving module, a first decoder, a second decoder, a synchronization module, a shader module and a display module. The receiving module is configured to receive a first video stream including RGB data and a second video stream including grayscale mask data. The first decoder is configured to decode the RGB data from the first video stream to obtain base frame information. The second decoder is configured to decode the grayscale mask data from the second video stream to obtain alpha channel values. The synchronization module is configured to synchronize the decoded RGB and alpha frames based on presentation timestamps. The shader module is configured to composite the synchronized RGB and alpha frames to generate a blended output. The display module is configured to display the blended output to a user in real time.

In an embodiment of the present disclosure, the first decoder and the second decoder operate in parallel processing threads to reduce decoding latency and maintain frame-level temporal alignment between the RGB data and the grayscale mask data.

In an embodiment of the present disclosure, the synchronization module advances frame rendering when the presentation timestamps of the decoded RGB frames and the decoded alpha frames satisfy a pre-defined synchronization condition.

In an embodiment of the present disclosure, the system further includes an intelligent frame buffer configured to temporarily store the paired decoded RGB frames and the alpha frames prior to the compositing to enable frame verification, latency compensation, and deterministic synchronization.

In an embodiment of the present disclosure, the shader module performs compositing using a two-pass rendering process. The two-pass rendering process includes a first pass that processes the decoded RGB frame data and a second pass that applies the decoded alpha channel data to generate the blended RGBA output frames.

In an embodiment of the present disclosure, the first decoder is implemented using hardware-accelerated decoding components and the second decoder is implemented using software-based or GPU-assisted decoding to balance computational load across processing resources.

In an embodiment of the present disclosure, the system supports video formats with embedded alpha channel information. The video formats include at least WebM and HEVC formats that encode transparency data natively.

In an embodiment of the present disclosure, the system further includes an error recovery module configured to interpolate missing or corrupted alpha values using preceding and succeeding frames to maintain visual continuity during playback.

In an embodiment of the present disclosure, the shader module and the display module cooperate to dynamically discard rendered frames after display and blend the decoded frames within a mixed-reality environment to enable real-time integration of virtual content with physical scenes.

In another aspect, a method for decoding and synchronizing alpha channel information from dual video streams on a communication device is disclosed. The method includes the first step of receiving, a first video stream including RGB data and a second video stream including grayscale mask data by a receiving module. The method includes the second step of decoding the RGB data by a first decoder to obtain base frame information. The method includes the third step of decoding the mask data by a second decoder to obtain alpha channel values. The method includes the fourth step of Synchronizing the decoded RGB and alpha frames based on presentation timestamps by a synchronization module. The method includes the fifth step of compositing the synchronized RGB and alpha frames to generate a blended output by a shader module and lastly a sixth step of displaying the blended output to a user by a display module.

In yet another aspect, a non-transitory computer-readable medium is disclosed. The non-transitory computer-readable medium stores instructions that, when executed by one or more processors, cause a system to perform a method for decoding and synchronizing alpha channel information from dual video streams on a communication device. The method includes the first step of receiving, a first video stream including RGB data and a second video stream including grayscale mask data by a receiving module. The method includes the second step of decoding the RGB data by a first decoder to obtain base frame information. The method includes the third step of decoding the mask data by a second decoder to obtain alpha channel values. The method includes the fourth step of Synchronizing the decoded RGB and alpha frames based on presentation timestamps by a synchronization module. The method includes the fifth step of compositing the synchronized RGB and alpha frames to generate a blended output by a shader module and lastly a sixth step of displaying the blended output to a user by a display module.

In an embodiment of the present disclosure, the instructions cause execution of a two-pass rendering process. The two-pass rendering process includes a first pass that processes the decoded RGB frame data and a second pass that applies the decoded alpha channel data to generate the blended RGBA output frames.

### BRIEF DESCRIPTION OF DRAWINGS

For a better understanding of the various described embodiments, reference should be made to the Detailed Description below, in conjunction with the following drawings in which like reference numerals refer to corresponding parts throughout the figures.

FIG. 1A illustrates a schematic block diagram of a computing environment implementing a system for decoding and synchronizing alpha channel information from dual video streams, in accordance with various embodiments of the present disclosure;

FIG. 1B illustrates a flowchart representing a method for decoding and synchronizing the alpha channel information from the dual video streams on a communication device, in accordance with various embodiments of the present disclosure. ;

FIG. 2 illustrates an exemplary frame sequence representing a progressive transformation of RGB and grayscale mask video streams into a final blended output, as processed by the system of FIG. 1A, in accordance with embodiments of the present disclosure; and

FIG. 3 illustrates a block diagram of the communication device executing the dual-decoder transparency decoding and rendering process, in accordance with various embodiments of the present disclosure.

In accordance with common practice, the various features illustrated in the drawings may not be drawn to scale. Accordingly, the dimensions of the various features may be arbitrarily expanded or reduced for clarity. In addition, some drawings may not depict all the components of a given system, method, or device. Finally, like reference numerals may be used to denote features throughout the specification and figures.

### DETAILED DESCRIPTION

In the following description, for the purposes of explanation, various specific details are set forth to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. Various changes may be made in the function and arrangement of elements without departing from the spirit and scope of the disclosure as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” or “an implementation” or “one implementation” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the features, structures, or characteristics may be combined in any suitable manner in one or more embodiments.

The terminology used herein is for the purpose of describing embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure relates to a method and system for decoding and synchronizing alpha channel information from dual video streams on a communication device. More particularly, the invention provides a dual-decoder architecture and frame-synchronization mechanism that enable real-time decoding, blending, and rendering of transparency information in video content. The disclosed method and system allow seamless compositing of digital video with real-world scenes, thereby delivering high-fidelity, visually integrated, and immersive viewing experiences in mixed reality (MR), augmented reality (AR), and other advanced visual environments.

The decoding and synchronizing of alpha channel information from dual video streams refers to a process in which two video inputs are decoded in parallel. One video input contains base RGB data and another contains grayscale mask or alpha information. The two input videos are synchronized frame-by-frame using presentation timestamps and composited to generate final RGBA frames. The base video stream represents the primary visual content, while the mask video stream contains corresponding luminance-based transparency information. Each pixel in the mask stream defines the visibility level of the corresponding pixel in the base stream, allowing portions of the video to appear transparent, semi-transparent, or fully opaque. Through real-time decoding and synchronization, the invention enables accurate per-pixel blending of digital imagery with physical backgrounds or live camera feeds.

In the present disclosure, the invention introduces a scalable, device-agnostic, and latency-optimized framework for decoding and synchronizing alpha channel information from dual video streams. The system ensures pixel-level accuracy, stable synchronization, and efficient blending of video layers, enabling natural integration of digital content with real-world environments. The invention provides a foundation for the next generation of real-time, transparency-enabled media applications through its modular architecture and adaptive rendering pipeline.

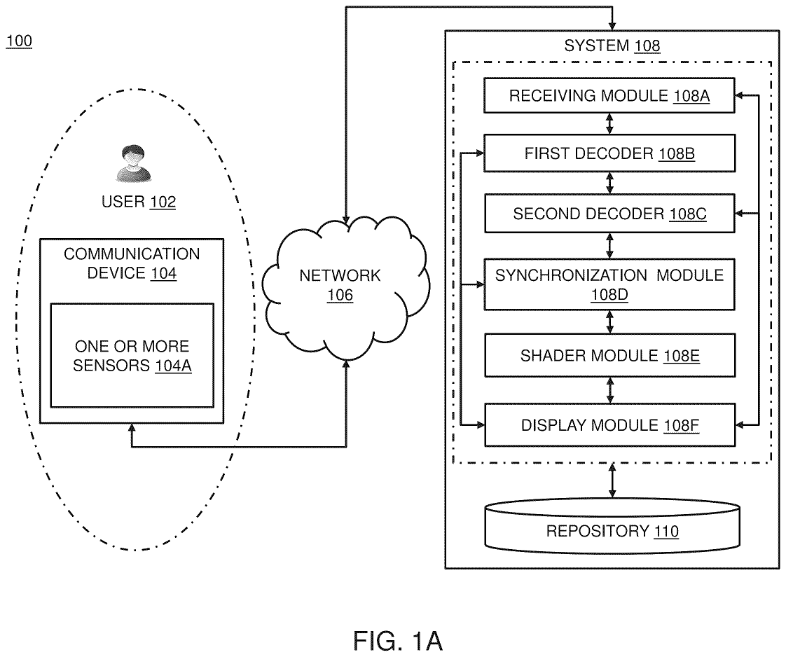

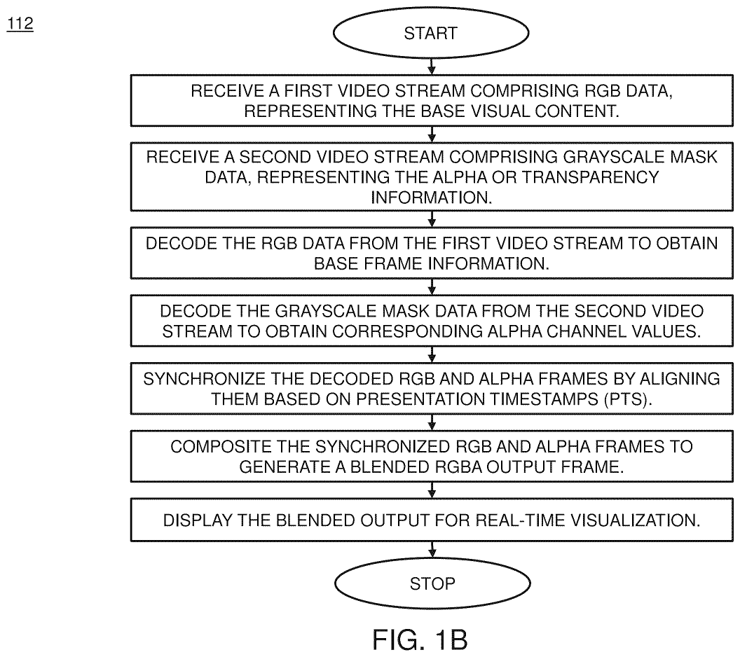

FIG. 1A illustrates an exemplary environment 100 for enabling decoding and synchronization of alpha channel information from dual video streams, in accordance with various embodiments of the present disclosure. The exemplary environment 100 includes a communication device 104 associated with a user 102 and optionally equipped with one or more sensors 104a. Also, the environment 100 includes a network 106, a system 108 and a repository 110. The system 108 is configured for decoding and synchronizing alpha channel information. The repository 110 stores video data, mask data, or processed frame buffers.

The environment 100 provides a computing framework that supports the acquisition, transmission, decoding, synchronization, and real-time visualization of dual video streams containing both RGB base content and corresponding grayscale mask or alpha data. In various embodiments, the environment 100 facilitates frame-level synchronization between these dual video streams, enabling accurate per-pixel compositing through the system 108. The shader-based rendering components synchronize frames to produce blended RGBA output. The blended RGBA output is displayed to the user 102 in real time. In certain embodiments, the repository 110 stores metadata descriptors or timestamp information used by the synchronization module 108D to align RGB and alpha frames precisely. The described environment ensures a seamless and stable decoding pipeline capable of maintaining transparency fidelity even under varying network or processing conditions.

The environment 100 enables seamless playback of alpha-decoded video overlays across a variety of real-time applications. Examples of such applications may include augmented-reality (AR) visualization, mixed-reality (MR) interaction, gaming environments, virtual product rendering in e-commerce, and interactive digital media experiences. The environment 100 integrates dual-stream decoding, alpha extraction, and frame-synchronized compositing within the unified system 108. Through this integration, the environment 100 allows alpha-encoded or mask-based video elements to blend naturally with real-world imagery, live camera feeds, or digital scene backgrounds. The environment 100 ensures that each rendered frame maintains pixel-level correspondence between color and transparency data. Also, the environment preserves spatial consistency, temporal accuracy, and visual fidelity during continuous playback and delivers a smooth and immersive user experience across devices and display interfaces.

The user 102 interacts with the communication device 104 to view, capture, or stream video content containing synchronized RGB and alpha channel information. The user 102 may be an operator, consumer, or developer interacting with transparency-enabled video overlays integrated with the surrounding environment. The communication device 104 serves as the user's interface for executing the decoding, synchronization, and rendering functions of the system 108. The communication device 104 may include an intelligent frame buffer configured to temporarily store paired RGB and alpha frames before local processing or compositing.

The communication device 104 is a computing platform configured to process dual video streams, decode synchronized RGB and alpha data, and display composited frames in real time. Examples of the communication device 104 include smartphones, tablets, head-mounted displays, projection-based visors, or portable media players equipped with advanced graphics or GPU hardware. The communication device 104 executes one or more software or firmware components that collectively implement the modules of the system 108.

The one or more sensors 104a are integrated within or operatively coupled to the communication device 104. The one or more sensors 104a include at least one RGB camera for capturing live background imagery, a depth sensor for determining spatial positioning, or an ambient-light sensor for adaptive display adjustment. In mixed-reality embodiments, the one or more sensors 104a provide live environmental or positional data used to spatially anchor the alpha-decoded video frames within the real-world scene. Each video frame may further include metadata such as orientation, frame index, codec type, synchronization timestamp, and stream identifier to ensure deterministic alignment and decoding by the system 108.

The network 106 provides communication connectivity between the communication device 104 and the system 108. The network 106 may include one or more wired or wireless links such as Wi-Fi, 5G, LTE, or satellite connections. The network 106 supports high-throughput transmission of dual video streams, alpha metadata, and adaptive bitrate control signals. The network 106 ensures that RGB and alpha frames remain time-synchronized across distributed playback or collaborative rendering environments. Network packets and streaming manifests may include signed metadata fields and container-level descriptors indicating stream orientation, alpha mapping parameters, and expected encoding format, such as MP4/H.264 dual-stream or WebM/HEVC embedded-alpha configurations.

The system 108 represents a computational entity configured to perform the decoding, synchronization, and rendering of alpha channel information from the dual video streams. The system 108 may operate locally on the communication device 104, on an edge-computing node, or remotely within a cloud platform. The system 108 coordinates data reception, parallel decoding of RGB and alpha frames, timestamp-based synchronization, compositing, and display control to generate transparency-corrected visual output. In one embodiment, the system 108 executes a two-pass decoding path in which color and alpha layers are processed separately and subsequently merged to preserve full spatial and temporal resolution for transparency-rich or multi-layer video content.

In one embodiment, the system 108 includes an internal architecture composed of multiple functional modules, such as a receiving module 108A, first decoder 108B, second decoder 108C, synchronization module 108D, shader module 108E, display module 108F, and an intelligent frame buffer. These modules collectively implement the dual-decoder pipeline for extracting alpha channel information from synchronized video streams and generating blended RGBA output frames. The architecture enables parallel decoding, precise timestamp alignment, and real-time compositing of color and transparency data to produce visually integrated video content.

The system 108 cooperates with the communication device 104 to acquire dual video streams. The dual video streams include a first video stream and a second video stream. The first video stream represents RGB color information. The second video stream represents corresponding alpha or grayscale mask information. The first video stream and the second video stream are provided as logically separate video inputs that remain distinct throughout the decoding process. The system 108 interprets stream-level metadata to maintain pixel-level correspondence and frame-accurate synchronization between the RGB data and the alpha data during decoding and rendering. The metadata includes at least presentation timestamps and frame indices.

The repository 110 stores encoded dual video streams, alpha channel metadata, and format descriptors for retrieval and playback. The repository 110 may reside locally on the communication device 104, on an edge server, or within a cloud-hosted database accessible via the network 106. In streaming scenarios, the repository 110 supports adaptive bitrate delivery to accommodate fluctuating bandwidth conditions without interrupting synchronized alpha decoding. The repository 110 may further archive historical performance data that enables the system 108 to select optimal descriptor distributions adaptively, based on device capabilities, network conditions, or environmental context.

The system 108 decodes the dual video streams using a unified pipeline that separates the RGB color data from the corresponding alpha channel data. The system 108 extracts alpha values from the decoded mask stream and maps them to their corresponding pixels in the decoded RGB frames to generate a blended RGBA output frame. The system 108 renders the composited frame on the display interface of the communication device 104 in real time, ensuring synchronized playback between color and transparency layers. The transparent regions accurately reveal the live environment or digital background with consistent opacity gradients and edge precision.

In operation, the environment 100 enables dynamic transparency rendering across various usage contexts. In an example implementation, the communication device 104 streams dual video inputs containing synchronized RGB and alpha channel data. The system 108 decodes each incoming frame pair and computes corresponding alpha coefficients for real-time blending. The resulting composite is merged with the live background scene captured by the one or more sensors 104a, producing a seamless visual experience where digital video elements appear naturally integrated within the physical environment. When video frames include multiple visual channels, the system 108 employs GPU-assisted processing to extract the active channel before descriptor generation, ensuring precise alignment between the RGB and alpha data.

The system 108 performs adaptive control to ensure smooth playback under varying computational or network conditions. The system 108 monitors device performance metrics such as GPU utilization, memory usage, and decoding throughput in real time. Based on these metrics, the system 108 dynamically adjusts video resolution, shader sampling density, or streaming bitrate to maintain synchronization between the RGB and alpha channels. These adaptive adjustments preserve visual fidelity, prevent frame drops, and sustain stable transparency rendering across different device and network configurations.

In an embodiment, the system 108 employs an intelligent frame buffer that temporarily stores paired RGB and alpha data for one or more frames. The frame buffer ensures precise temporal alignment between the two data types and performs corrective interpolation when missing or corrupted alpha information is detected. This mechanism prevents flicker and maintains frame-accurate synchronization throughout playback. The intelligent frame buffer retains paired color and transparency data during the two-pass decoding sequence to guarantee alignment before final compositing.

The environment 100 supports both standalone and connected operational modes. In standalone configurations, the communication device 104 performs the decoding, synchronization, and compositing operations locally using the system 108. In connected configurations, the system 108 offloads portions of the computation, such as decoding or shader processing, to a cloud-based or edge-processing node, while the communication device 104 handles display rendering and user interaction. This distributed architecture ensures scalability, efficient resource utilization, and consistent real-time performance across devices with varying processing capabilities.

The computing environment 100 establishes a foundation for decoding, synchronizing, and rendering alpha channel information from the dual video streams. The system 108 integrates sensor-based contextual awareness, adaptive dual-decoder processing, and GPU-accelerated compositing to enable real-time generation of visually coherent transparency overlays. The resulting alpha-video overlays are suitable for mixed-reality environments, interactive digital media, and advanced content visualization applications.

The environment 100 provides error-handling mechanisms to manage corrupted or missing alpha data. When a decoded mask frame is partially unavailable or corrupted, the intelligent frame buffer initiates temporal interpolation or requests retransmission through the network 106. The system 108 may record frame integrity failures within associated metadata to enable fallback alpha estimation or reuse of the previous frame's alpha values, thereby maintaining visual continuity during playback.

The display interface of the communication device 104 presents the final blended output generated by the system 108. The display interface may render the composited video over a live camera feed for augmented reality applications or as a standalone transparent video over a virtual background for mixed-reality visualization. The display interface interprets blending instructions and alpha mapping profiles embedded as metadata with each decoded frame to ensure accurate transparency rendering and visual consistency.

The system 108 supports adaptive optimization to ensure consistent performance across heterogeneous devices. An optimization component monitors GPU load, decoder throughput, and memory utilization, and applies adaptive controls such as downscaling frame resolution, switching to two-pass alpha extraction, or selecting a lower-complexity alpha mapping profile to maintain stable frame rates and visual fidelity. The optimization component may analyze metadata telemetry to dynamically select the most efficient strategy based on current device and network conditions.

The system 108 enables multi-device synchronization for collaborative playback scenarios. Participating devices exchange timestamped metadata and alignment information to ensure that identical video assets remain frame-synchronized across users. Shared metadata fields, including global session time and frame anchor identifiers, maintain consistent alpha application and timing accuracy across devices. The system 108 thereby establishes a metadata-rich, error-resilient, and adaptive framework for delivering dual-stream and embedded-alpha video content across heterogeneous platforms. The architecture combines the simplicity of single-decoder playback with the robustness of two-pass processing to maximize compatibility, synchronization precision, and visual accuracy.

The number and arrangement of components shown in FIG. 1A are exemplary and may vary depending on implementation. Additional repositories, network layers, or display interfaces may be incorporated to support specific deployment scenarios. Alternatively, the functional blocks of the system 108 may be distributed across multiple computing nodes or integrated within the communication device 104 to optimize performance and resource utilization.

Further, the system 108 includes a plurality of functional modules. The plurality of functional modules include a receiving module 108A, a first decoder 108B, a second decoder 108C, a synchronization module 108D, a shader module 108E, and a display module 108F. Each of the plurality of functional modules executes program instructions stored in one or more memories and operatively coupled to one or more processors of the system 108. The plurality of functional modules collectively perform the method for decoding and synchronizing alpha channel information from dual video streams on the communication device 104, as illustrated through a flowchart 112 in FIG. 1B. The method defines a sequential process executed by the system 108 to enable real-time decoding, synchronization, and rendering of video content containing transparency data from separate or embedded alpha sources.

The receiving module 108A is configured to receive the first video stream and the second video stream. The first video stream includes the RGB data. The second video stream includes grayscale mask data. The first video stream and the second video stream are received as synchronized yet independent inputs. Each received frame pair corresponds to a common presentation timestamp and frame index. The receiving module 108A prepares the received video streams for decoding by validating stream metadata, preserving frame order, and maintaining temporal alignment between the RGB frames and the alpha frames. This operation corresponds to the receiving step illustrated in FIG. 1B.

The receiving module 108A interprets container metadata, identifies the stream configuration, and forwards frames to downstream components. In certain embodiments, the receiving module 108A validates frame indices, manages buffering, and annotates the data streams with metadata such as timestamps, orientation, codec type, and synchronization identifiers. The annotations ensure deterministic alignment between the RGB and alpha data streams during decoding. The receiving module 108A may also coordinate with the optimization module 108F to regulate bitrate, manage adaptive buffering, or prefetch frames based on available network bandwidth.

The receiving module 108A interprets metadata defining the stream configuration, frame dimensions, frame rate, and encoding parameters. Based on this metadata, the receiving module 108A processes the dual video streams or stitched frames in the correct orientation and maintains both spatial and temporal synchronization between the RGB color data and the corresponding alpha data. This synchronization ensures that each alpha or luminance value precisely aligns with its corresponding pixel in the RGB base frame within the same decoding cycle.

In an embodiment, the first video stream and the second video stream are encoded using industry-standard codecs, including H.264 or H.265, within container formats such as MP4, WebM, or HEVC. The encoding formats may store the RGB data and the alpha data as separate elementary streams or as logically distinct tracks within a container. The receiving module 108A processes the encoding metadata to identify stream boundaries, synchronization parameters, and decoding requirements, without combining the RGB data and the alpha data into a stitched frame structure.

The receiving module 108A manages frame buffering and sequence control for the first video stream and the second video stream independently while preserving deterministic synchronization. The frame indices and the presentation timestamps are used to ensure that the corresponding RGB and alpha frames are forwarded together to the decoding stage. Random access operations, such as seeking or scrubbing, retrieve matched RGB and alpha frames based on their shared frame identifiers. When missing or corrupted frames are detected, the receiving module 108A initiates retransmission requests or frame interpolation procedures to preserve continuity and synchronization across the dual video streams.

The base and alpha data segments may be encoded within the same frame of a stitched video or transmitted as two synchronized streams, enabling frame-accurate random-access operations. For example, seeking a specific frame retrieves both the RGB and alpha information simultaneously, ensuring that the playback seeker remains synchronized between the color and transparency channels without requiring external multi-stream coordination. The receiving module 108A verifies the integrity of incoming frames through checksum validation or frame-index tracking to detect missing or corrupted data. When an irregularity is detected, the receiving module 108A may request retransmission of the affected segments or trigger interpolation to preserve continuity. The structured and time-aligned delivery of frame data allows the two decoder frames to operate concurrently, extracting and decoding RGB and alpha information in parallel with frame-level precision for synchronized compositing.

The first decoder 108B decodes the RGB base stream. The second decoder 108C decodes the corresponding alpha or mask stream received from the receiving module 108A. The first decoder 108B and the second decoder 108C operate concurrently in separate processing threads to maintain frame-level synchronization. Upon decoding, the first decoder 108B outputs the base color frames, and the second decoder 108C extracts grayscale intensity values representing per-pixel transparency. The dual-decoder configuration ensures real-time, frame-accurate alignment between the color data and the transparency data. Each decoder interprets metadata from the receiving module 108A to identify frame orientation, resolution, and timestamp parameters for synchronized processing.

During operation, the first decoder 108B and the second decoder 108C maintain pixel-level correspondence between the decoded RGB data and the alpha data. Each alpha pixel directly maps to a specific color pixel, ensuring accurate transparency application in later stages of compositing. The dual-decoder structure guarantees frame-accurate synchronization and prevents temporal or spatial drift between the RGB and alpha layers. In addition, the first decoder 108B and the second decoder 108C operate within a unified timing framework managed by the synchronization module 108D. The synchronization module 108D verifies alignment based on presentation timestamps.

In an embodiment, the first decoder 108B and the second decoder 108C operate in parallel processing threads to reduce latency. In this embodiment, the first decoder 108B executes in a first processing thread dedicated to decoding the RGB base frames. The second decoder 108C executes in a second, separate processing thread dedicated to decoding grayscale mask or alpha frames. The parallel execution allows both the decoders 108B-108C to process corresponding frames concurrently rather than sequentially for minimizing end-to-end decoding latency. The operation of the first decoder 108B and the second decoder 108C in parallel processing threads ensures that the RGB data and the alpha data for a given frame become available within the same temporal window. Accordingly, the parallel processing threads operation reduces synchronization delay and improves real-time playback performance, particularly on devices with multi-core processors or heterogeneous CPU-GPU architectures.

In an embodiment, the first decoder 108B and the second decoder 108C operate in parallel processing threads, such that the decoding of the RGB data and decoding of the alpha data proceed concurrently for each frame pair. Hardware-accelerated decoding resources are preferentially assigned to the first decoder 108B for processing the RGB data. The second decoder 108C executes software-assisted or GPU-assisted decoding for the alpha data. The parallel execution reduces end-to-end latency and balances computational load across heterogeneous decoding resources.

The first decoder 108B and the second decoder 108C support standard video codecs such as H.264 and H.265 within container formats including MP4, WebM, or HEVC. This ensures compatibility with consumer-grade hardware decoders while allowing alpha data to be processed separately through software or shader-assisted decoding. By leveraging existing hardware decoding capabilities for the RGB stream and software-based decoding for the alpha stream, the dual-decoder design maintains high efficiency without requiring architectural changes to native video decoders. The decoded frames are written to an intermediate frame buffer where RGB and alpha data occupy synchronized memory regions, allowing continuous data flow to the shader module 108E for compositing.

In an embodiment, the first decoder 108B and the second decoder 108C include error detection and correction mechanisms to ensure reliable frame reconstruction. Each decoder validates frame indices and timestamps to detect missing or corrupted frames. When inconsistencies occur, the synchronization module 108D triggers predictive interpolation or retransmission requests through the receiving module 108A to preserve temporal continuity. These recovery mechanisms prevent flicker or visual artifacts during playback and maintain seamless alignment between the decoded RGB and alpha frames.

The first decoder 108B and the second decoder 108C output the decoded data in GPU-readable formats such as YUV, NV12, or RGBA, depending on the hardware configuration of the communication device 104. The first decoder 108B and the second decoder 108C interface directly with GPU memory, minimizing data transfer latency and improving overall frame throughput. Operating under real-time constraints, the dual decoders complete decoding and data transfer within the frame duration defined by the playback rate, typically between 24 and 60 frames per second. This low-latency decoding pipeline enables the system 108 to render transparency effects immediately after decoding, ensuring smooth, synchronized playback of video content containing alpha information.

The synchronization module 108D aligns the decoded RGB frames generated by the first decoder 108B with the corresponding alpha frames produced by the second decoder 108C. The synchronization module 108D uses the presentation timestamps and frame indices to ensure temporal alignment of the dual data streams before compositing. The synchronization module 108D compensates for decoding latency and network jitter by buffering frames and releasing each frame only when both RGB and alpha components for the same frame are available.

The synchronization module 108D continuously monitors decoding throughput and timestamp drift between the base video stream and the mask video stream to maintain frame-level alignment. When minor mismatches occur, the synchronization module 108D adjusts playback timing or advances one stream to match the other. The synchronization module 108D utilizes predictive algorithms or time-delta correction techniques to realign frames dynamically without interrupting playback. This operation ensures that color data and transparency data remain spatially and temporally coherent and maintain smooth visual transitions in the rendered video sequence.

The synchronization module 108D interfaces with the intelligent frame buffer to store and release paired frames in synchronized order. Each paired RGB frame and alpha frame is validated for timestamp accuracy before being transferred to the shader module 108E for alpha mapping. When the synchronization module 108D detects missing or corrupted alpha frames, the synchronization module 108D initiates interpolation or requests retransmission through the receiving module 108A. The synchronization module 108D maintains deterministic timing between the first decoder 108B and the second decoder 108C and ensures that all blended frames are rendered with pixel-level accuracy and stable transparency alignment.

In an embodiment, the system 108 includes an error recovery mechanism configured to interpolate missing alpha values based on preceding and succeeding frames when incomplete or corrupted alpha data is detected. The interpolation is performed within the synchronization module 108D or the intelligent frame buffer and preserves transparency continuity without interrupting playback.

In an embodiment, the synchronization module 108D advances frame rendering when the presentation timestamps of the first video stream and the second video stream match. The synchronization module 108D compares the presentation timestamps associated with decoded RGB frames generated by the first decoder 108B and the decoded alpha frames generated by the second decoder 108C. When the presentation timestamps for a corresponding pair of frames are determined to match, the synchronization module 108D releases the frame pair for compositing and rendering. The synchronization module 108D advances frame rendering only when timestamp alignment is achieved to ensure deterministic frame pairing, prevent temporal drift between the color data and the transparency data, and preserve the pixel-level synchronization across the rendering pipeline. The mechanism is particularly critical for maintaining visual coherence during real-time playback under variable decoding or network conditions.

In an embodiment, the system 108 may include an error recovery module configured to interpolate missing alpha values based on preceding and succeeding frames to maintain visual continuity. The error recovery module detects missing, corrupted, or incomplete alpha channel values produced by the second decoder 108C as a result of transmission errors, compression artifacts, or frame loss. Upon detecting such inconsistencies, the error recovery module computes replacement alpha values by interpolating the transparency data derived from temporally adjacent frames, including at least one preceding frame and at least one succeeding frame. The interpolation operation may be performed using temporal averaging, weighted prediction, or motion-compensated estimation techniques to preserve smooth transparency gradients across frames. By reconstructing the missing alpha values before compositing, the error recovery module prevents flicker, transparency discontinuities, and abrupt visual artifacts in the blended output. In certain embodiments, the error recovery module operates in coordination with the intelligent frame buffer and the synchronization module 108D to ensure that reconstructed alpha data remains frame-aligned with the corresponding RGB data prior to rendering.

The shader module 108E extracts alpha values corresponding to pixel intensity from the mask data decoded by the second decoder 108C. Using GPU-accelerated fragment shaders, the shader module 108E maps grayscale intensity values to normalized alpha coefficients ranging from 0.0 (fully transparent) to 1.0 (fully opaque). The conversion is performed in real time using programmable graphics pipelines such as OpenGL, Vulkan, or equivalent GPU frameworks. The shader module 108E executes per-pixel operations in parallel to ensure real-time transparency extraction while maintaining synchronization with the RGB base frames decoded by the first decoder 108B.

The shader module 108E performs transparency extraction across all pixels within each frame using the parallel computing architecture of the GPU. This parallelized computation reduces processing latency and ensures that alpha extraction occurs within the same temporal window as frame decoding. The combination of hardware-based RGB decoding by the first decoder 108B, software-based alpha decoding by the second decoder 108C, and GPU-driven alpha mapping by the shader module 108E enables the system 108 to achieve real-time transparency rendering at playback frame rates between 24 and 60 frames per second.

The shader module 108E stores the extracted alpha data in temporary GPU memory buffers associated with the corresponding RGB data decoded from the same frame. The shader module 108E maintains pixel-level correspondence between each alpha coefficient and its corresponding RGB pixel coordinate to preserve spatial accuracy and prevent edge misalignment. The shader module 108E applies sub-pixel interpolation to smooth gradients between transparency levels and eliminate visual artifacts such as banding or aliasing. Floating-point computation is employed to ensure accurate rendering of fine transparency variations, such as shadows, reflections, and semi-transparent textures.

In an embodiment, the system 108 includes the intelligent frame buffer configured to temporarily store the decoded RGB frames and the decoded alpha frames prior to compositing. The intelligent frame buffer verifies frame integrity, timestamp alignment, and completeness of each RGB-alpha frame pair before releasing the paired frames for subsequent processing. Further, the intelligent frame buffer further supports frame reordering, temporal smoothing, and missing-alpha estimation to maintain continuous playback and frame-accurate synchronization.

The shader module 108E supports configurable transparency profiles that define how luminance values correspond to alpha coefficients. Based on metadata received from the receiving module 108A or encoding parameters within the video stream, the shader module 108E applies linear, inverted, or custom transfer functions to control transparency mapping. This configurability allows adaptive alpha interpretation suited to different encoding schemes or visual presentation requirements.

The shader module 108E incorporates error mitigation mechanisms to address inconsistencies in the decoded alpha data. When luminance values are missing, clipped, or corrupted due to compression artifacts, the shader module 108E performs spatial averaging or temporal interpolation using data from adjacent pixels or frames to estimate replacement alpha values. This correction maintains transparency continuity and prevents visible flicker or discontinuity in the rendered output.

After extracting and validating alpha information, the shader module 108E composites the synchronized RGB and alpha frames to generate a blended RGBA output. The compositing operation is executed within GPU memory using low-latency blending routines to ensure real-time rendering. This integrated shader-based compositing approach eliminates the need for a separate compositing module and ensures smooth frame blending without perceptible delay between decoding and display.

In such embodiments, the shader module 108E merges the RGB data and the alpha data through a two-pass rendering process to produce the final RGBA frames. In the two-pass rendering process, a first rendering pass processes the RGB data decoded by the first decoder 108B to generate an intermediate color frame without transparency information. In a second rendering pass, the shader module 108E applies the alpha channel values decoded by the second decoder 108C to the intermediate color frame on a per-pixel basis. The shader module 108E combines the outputs of the first rendering pass and the second rendering pass within GPU memory to generate the final RGBA frame. In the final RGBA frame, each RGB pixel is assigned a corresponding transparency coefficient derived from the alpha data. The two-pass rendering process ensures that the color decoding and the transparency application are computationally decoupled and remain temporally synchronized. This improves rendering stability, reduces blending artifacts, and enables precise pixel-level transparency control, particularly for high-resolution or transparency-rich video content.

The shader module 108E dynamically adjusts its processing parameters according to the GPU load, decoding throughput, and available system resources of the communication device 104. The adaptive execution strategy maintains consistent frame rates, efficient transparency extraction, and stable visual output under variable computational or network conditions.

The display module 108F is configured to render the final blended output generated by the shader module 108E on the display interface of the communication device 104 in real time. The display module 108F retrieves the composited RGBA frame from GPU memory and displays it on the device's screen or projection surface. The display module 108F maintains synchronization with the display refresh rate to ensure smooth playback and visually consistent rendering of transparency effects.

In certain embodiments, the display module 108F renders the blended frames over live camera or sensor-captured imagery to enable augmented or mixed-reality visualization. The display module 108F ensures that transparency-rendered video content aligns naturally with real-world visuals, maintaining high visual fidelity and minimal latency. The display module 108F may adjust frame rendering based on ambient brightness data captured by the one or more sensors 104a to preserve visual consistency under varying environmental conditions.

The display module 108F interfaces directly with the graphics subsystem of the communication device 104, such as the GPU frame buffer or display controller, to access composited frames stored in GPU memory. The display module 108F handles continuous rendering of frames at playback rates ranging from 24 to 60 frames per second or higher, depending on device performance. Synchronization with the display refresh rate prevents tearing, ghosting, or dropped frames. The display module 108F manages the presentation queue using double-buffering or triple-buffering techniques to ensure uninterrupted playback and correct temporal sequencing of transparency-rendered frames.

In one embodiment, the display module 108F overlays the composited frames directly on live imagery captured by the one or more sensors 104a, such as a camera or depth sensor. This allows the system 108 to operate in real-time augmented or mixed-reality environments where decoded video content merges seamlessly with physical scenes. The display module 108F references positional and orientation data from the one or more sensors 104a to maintain spatial alignment of rendered video elements during user or device movement.

The display module 108F performs dynamic visual adaptation by adjusting brightness, contrast, and transparency intensity of the composited frames in response to ambient light conditions detected by the one or more sensors 104a. This adaptation ensures consistent transparency perception across varying environments. For example, when ambient light increases, the display module 108F raises opacity to preserve contrast, and under low-light conditions, it increases transparency to maintain natural visual balance.

The display module 108F supports rendering of final frames on multiple display surfaces, including handheld screens, head-mounted displays, projection visors, and extended-reality interfaces. The display module 108F adjusts rendering resolution and scaling according to the target display's pixel density, aspect ratio, and refresh rate to prevent distortion and maintain the sharpness of transparency effects across output devices.

In one embodiment, the display module 108F includes a color management process that ensures accurate color reproduction and consistent visual output. The color management process performs tone mapping, gamma correction, and color-space conversions, such as YUV to sRGB or Rec. 709, to preserve the natural appearance of composited frames and prevent color distortion in transparency-rendered content.

The display module 108F dynamically manages rendering parameters to maintain stable performance across devices with varying graphics capabilities. When GPU utilization increases or frame throughput decreases, the display module 108F may temporarily lower rendering resolution or frame rate to sustain real-time output. When resources become available, the display module 108F restores native playback settings to achieve maximum visual fidelity and smoothness.

In an embodiment, the display module 108F supports low-latency rendering for interactive applications such as augmented reality visualization, live streaming, and gaming. The display module 108F minimizes delay between compositing and display to provide immediate visual feedback in response to user input or environmental changes. This low-latency configuration enhances immersion and responsiveness in real-time scenarios.

The display module 108F includes error-handling mechanisms to maintain continuous playback during transient synchronization issues or incomplete frame delivery. When a blended frame fails to meet synchronization timing, the display module 108F redisplays the previous frame or interpolates transitional frames using temporal blending to prevent flicker or visual discontinuity in the rendered output.

In one embodiment, the display module 108F supports recording or streaming of the rendered output for applications such as live broadcasting, augmented reality capture, or digital production workflows. The display module 108F encodes the rendered transparency content using standard video formats such as MP4, WebM, or HEVC, allowing high-quality output for transmission or archival storage.

In an embodiment, the rendered frames are dynamically discarded after being displayed to optimize memory usage during continuous playback. After a blended RGBA frame is rendered on the display interface by the display module 108F, the system 108 releases or discards the rendered frame from temporary memory buffers, including GPU frame buffers and intermediate storage within the intelligent frame buffer. The dynamic discarding prevents accumulation of previously displayed frames and limits memory consumption during prolonged playback sessions. The system 108 manages the lifecycle of rendered frames using buffer reuse or memory recycling techniques to ensure that buffer space is promptly reclaimed for subsequent frames. This memory management strategy enables sustained real-time rendering performance, particularly on resource-constrained communication devices, without compromising synchronization accuracy or visual fidelity.

Through this configuration, the display module 108F delivers high-fidelity visualization of alpha-decoded video frames with accurate synchronization, adaptive brightness control, and consistent color rendering. The display module 108F integrates seamlessly with the communication device 104 hardware and sensors to project transparency-rendered video content in real time within both digital and physical environments, enabling natural and immersive visual experiences for augmented, mixed, and extended reality applications.

The method concludes when the system 108 generates and displays the final blended frame comprising the decoded RGB data from the first decoder 108B, the extracted alpha transparency data from the second decoder 108C, and any environmental background or live scene imagery captured by the one or more sensors 104a. The display module 108F renders the composited RGBA frame in real time, completing one decoding and rendering cycle. The method repeats continuously for each subsequent frame in the video sequence to achieve real-time playback of transparency-encoded content with consistent synchronization and visual accuracy.

In an alternative embodiment, the system 108 supports video formats that natively include an embedded alpha plane, including WebM with VP9, HEVC with alpha, or other emerging codecs. In such embodiments, the shader module 108E performs compositing using a two-pass rendering process, corresponding to the separately decoded RGB data and the alpha data. In a first decoding pass, the first decoder 108B decodes the RGB color information using native hardware decoding. In a second decoding pass, the second decoder 108C extracts or decodes alpha information using software-assisted or GPU-assisted execution. The decoded outputs of the two passes are merged into RGBA frame buffers prior to rendering. This two-pass approach ensures recovery and correct application of alpha data on devices that discard or ignore embedded alpha channels during single-pass hardware decoding.

Through the sequence of steps illustrated in FIG. 1B, the method establishes a dual-decoder, GPU-accelerated framework for decoding, synchronizing, and rendering the alpha channel information from the dual video streams. By processing the RGB and alpha data through parallel decoding paths and maintaining precise timestamp alignment, the method ensures pixel-level synchronization, minimizes computational latency, and enhances real-time rendering efficiency. The method supports smooth playback of transparency-encoded video content across applications such as augmented reality, mixed reality, gaming, and immersive digital visualization.

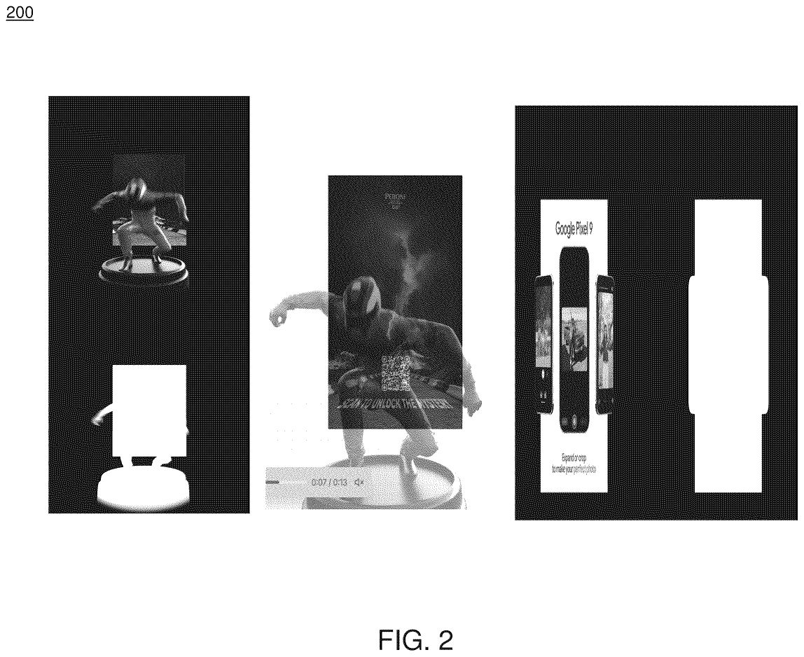

FIG. 2 illustrates an exemplary frame sequence 200 representing a progressive transformation of the dual video streams comprising RGB and grayscale mask data into a final blended output frame, in accordance with embodiments of the present disclosure. The sequence of visual frames 200 is processed by the system 108 for the dual-decoder frame-synchronized transparency decoding. The leftmost illustration depicts the base RGB frame decoded by the first decoder 108B and the corresponding grayscale alpha frame decoded by the second decoder 108C. The middle illustration represents the synchronized alignment of both decoded streams performed by the synchronization module 108D. The rightmost illustration shows the final blended RGBA output generated by the shader module 108E and displayed through the display module 108F.

The illustrated sequence demonstrates how the dual-decoder architecture processes and synchronizes two independent video streams to achieve accurate per-pixel transparency rendering. The first decoder 108B extracts RGB color information, while the second decoder 108C extracts corresponding alpha or transparency values from the grayscale mask. The synchronization module 108D aligns both decoded frames based on their presentation timestamps to ensure temporal coherence. The shader module 108E then merges the synchronized RGB and alpha data to produce a composite frame with precise transparency gradients. The final render illustrates how the decoded alpha information enables the virtual content to blend seamlessly with real-world or digital backgrounds, maintaining spatial and temporal consistency across all frames. The sequence collectively exemplifies how the system 108 achieves real-time transparency rendering using parallel dual-decoder processing and frame-level synchronization.

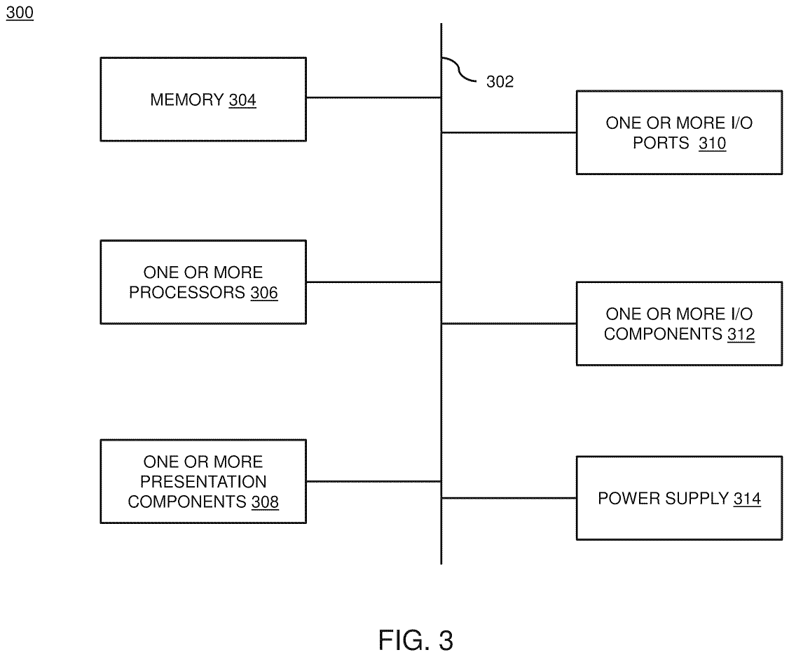

FIG. 3 illustrates a block diagram of the device 300, in accordance with various embodiments of the present disclosure. The device 300 is a non-transitory computer-readable storage medium. The device 400 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more buses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 3 is merely illustrative of an exemplary device 300 that can be used in connection with one or more embodiments of the present disclosure. Distinction is not made between such categories as “workstation,” “server,” “laptop,” “hand-held device,” etc., as all are contemplated within the scope of FIG. 3 and reference to “device.”

The device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The device 300 includes the one or more processors 306 that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the device 300 to be logically coupled to other devices including the one or more I/O components 312, some of which may be built in. Illustrative components include a microphone, joystick, game pad, satellite dish, scanner, printer, wireless device, etc.

In embodiments of the present disclosure, the dual-decoder architecture produces technical improvements in frame synchronization precision, processing parallelism, and alpha reconstruction accuracy. The invention establishes parallel hardware/software decoding pipelines that concurrently process the RGB and the alpha streams. The concurrent processing improves the decoding throughput and prevents bottlenecks associated with serialized channel extraction. The synchronization module implements the timestamp-based deterministic alignment logic that ensures frame progression only when the RGB and the alpha frames satisfy the pre-defined synchronization condition. The deterministic alignment prevents frame skew, temporal desynchronization, and alpha leakage. The intelligent frame buffer introduces latency compensation, temporal smoothing, and frame verification prior to compositing. Accordingly, the system enables loss-tolerant playback in variable network conditions. The two-pass rendering process separates the RGB processing and the ealpha application stages for ensuring complete alpha reconstruction on the hardware decoders that discard or ignore embedded alpha planes. The architecture corrects black-pixel artifacts caused by hardware decoders that output RGB (0,0,0) for the transparent pixels. The system recovers alpha explicitly and reconstitutes true transparency prior to display. Further, the GPU-assisted alpha extraction ensures per-pixel transparency mapping using normalized floating-point precision. The dynamic frame discarding and mixed-reality blending reduce memory overhead and maintain frame-rate stability during high-resolution playback. The error recovery interpolation reconstructs the missing alpha frames using temporal proximity logic, reducing flicker under partial packet loss. The above discussed technical enhancements or improvements produce a deterministic, synchronized, and latency-controlled alpha rendering system optimized for heterogeneous hardware platforms.

The present invention provides significant advantages over conventional video decoding and rendering systems. The invention is particularly beneficial in applications that require real-time transparency decoding, frame synchronization, and cross-device compatibility. One advantage of the invention includes a dual-decoder architecture in which a first decoder processes RGB data and a second decoder processes grayscale mask data in parallel. This configuration enables precise frame-level synchronization and eliminates desynchronization artifacts that occur in multi-stream video playback. The dual-decoder architecture distributes processing load between hardware components and software modules to improve operational efficiency and reduce decoding latency.

The invention includes a GPU-accelerated shader module that performs real-time extraction and conversion of alpha channel values from decoded mask data. The shader module merges synchronized RGB streams and alpha streams to generate composited RGBA frames. The GPU-based processing operation enhances rendering throughput and enables smooth playback of transparency-encoded video content. The GPU acceleration allows real-time transparency rendering on devices that do not include native alpha channel decoding functionality.

The synchronization module aligns decoded RGB frames and alpha frames using presentation timestamps to maintain temporal coherence during playback. The synchronization process ensures that each transparency value corresponds precisely to its associated color pixel in every frame. The generated output achieves high visual fidelity and pixel-level transparency accuracy. Such alignment is essential for mixed-reality, augmented-reality, and immersive media applications that require seamless compositing of visual layers.

The invention provides adaptive resource utilization for efficient system performance. The dual-decoder architecture supports flexible deployment configurations. The RGB decoding process operates through hardware acceleration, while alpha decoding operates through software or shader-based processing. This hybrid configuration balances computational load, minimizes power consumption, and maintains stable playback performance across various device architectures and network conditions.

The invention maintains compatibility with existing video formats and hardware infrastructure. The system supports dual-stream configurations and embedded-alpha video formats such as WebM and HEVC. The system integrates with standard playback pipelines without requiring proprietary codecs or specialized hardware for alpha processing. The interoperability of the invention enables deployment across both consumer and professional multimedia platforms.

The invention supports compositing of decoded transparency frames with environmental imagery or camera-captured video. The composited output blends virtual objects naturally with physical environments to achieve lifelike visualization. This feature enhances augmented-reality and mixed-reality experiences by maintaining visual consistency between digital and real-world content. The combination of parallel decoding, precise frame synchronization, and GPU-accelerated rendering establishes a scalable and efficient framework for high-fidelity transparency processing across multiple multimedia and immersive content applications.

The foregoing descriptions of specific embodiments of the present technology have been presented for the purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the disclosure have been described above and illustrated in some cases, it should be interpreted and understood as to have been presented only by way of illustration and example, but not by limitation. Thus, the breadth and scope of a preferred embodiment should not be limited by any of the above-described exemplary embodiments.

We claim:

1. A system for decoding and synchronizing alpha channel information from dual video streams on a communication device, the system comprising:
a receiving module configured to receive a first video stream comprising RGB data and a second video stream comprising grayscale mask data;
a first decoder configured to decode the RGB data from the first video stream to obtain base frame information;
a second decoder configured to decode the grayscale mask data from the second video stream to obtain alpha channel values;
a synchronization module configured to synchronize the decoded RGB frames and the alpha frames based on presentation timestamps;
a shader module configured to composite the synchronized RGB and the alpha frames to generate blended RGBA output frames; and
a display module configured to display blended RGBA output frames on the communication device in real time.

2. The system of claim 1, wherein the first decoder and the second decoder operate in parallel processing threads to reduce decoding latency and maintain frame-level temporal alignment between the RGB data and the grayscale mask data.

3. The system of claim 1, wherein the synchronization module advances frame rendering when the presentation timestamps of the decoded RGB frames and the decoded alpha frames satisfy a pre-defined synchronization condition.

4. The system of claim 1, further comprising an intelligent frame buffer configured to temporarily store the paired decoded RGB frames and the alpha frames prior to the compositing to enable frame verification, latency compensation, and deterministic synchronization.

5. The system of claim 1, wherein the shader module performs compositing using a two-pass rendering process, wherein the two-pass rendering process includes a first pass that processes the decoded RGB frame data and a second pass that applies the decoded alpha channel data to generate the blended RGBA output frames.

6. The system of claim 1, wherein the first decoder is implemented using hardware-accelerated decoding components and the second decoder is implemented using software-based or GPU-assisted decoding to balance computational load across processing resources.

7. The system of claim 1, wherein the system supports video formats with embedded alpha channel information, wherein the video formats comprise at least WebM and HEVC formats that encode transparency data natively.

8. The system of claim 1, further comprising an error recovery module configured to interpolate missing or corrupted alpha values using preceding and succeeding frames to maintain visual continuity during playback.

9. The system of claim 1, wherein the shader module and the display module cooperate to dynamically discard rendered frames after display and to blend the decoded frames within a mixed-reality environment to enable real-time integration of virtual content with physical scenes.

10. A method for decoding and synchronizing alpha channel information from dual video streams on a communication device, the method comprising:
receiving, by a receiving module, a first video stream comprising RGB data and a second video stream comprising grayscale mask data;
decoding, by a first decoder, the RGB data to obtain base frame information;
decoding, by a second decoder, the mask data to obtain alpha channel values;
synchronizing, by a synchronization module, the decoded RGB frames and the alpha frames based on presentation timestamps;
compositing, by a shader module, the synchronized RGB and alpha frames to generate blended RGBA output frames; and
displaying, by a display module, the blended RGBA output frames on a communication device in real time.

11. The method of claim 10, wherein the decoding by the first decoder (108B) and the decoding by the second decoder (108C) are performed in parallel processing threads to reduce decoding latency and maintain frame-level temporal alignment between the RGB data and the grayscale mask data.

12. The method of claim 10, wherein the synchronizing comprises advancing frame rendering when the presentation timestamps of the decoded RGB frames and the decoded alpha frames satisfy a pre-defined synchronization condition.

13. The method of claim 10, further comprising temporarily storing, by an intelligent frame buffer, the paired decoded RGB frames and the decoded alpha frames prior to the compositing to enable frame verification, latency compensation, and deterministic synchronization.

14. The method of claim 10, wherein the compositing comprises performing a two-pass rendering process, wherein the two-pass rendering process comprises a first pass that processes the decoded RGB frame data and a second pass that applies the decoded alpha channel data to generate the blended RGBA output frames.

15. The method of claim 10, wherein the decoding of the RGB data is performed using hardware-accelerated decoding components and the decoding of the grayscale mask data is performed using software-based or GPU-assisted decoding to balance computational load across processing resources.

16. The method of claim 10, wherein the method supports video formats with embedded alpha channel information, wherein the video formats comprise at least WebM and HEVC formats that encode transparency data natively.

17. The method of claim 10, further comprising interpolating, by an error recovery module, missing or corrupted alpha values using preceding and succeeding frames to maintain visual continuity during playback.

18. The method of claim 10, further comprising dynamically discarding rendered frames after display to optimize memory usage and blending the decoded frames within a mixed-reality environment to enable real-time integration of virtual content with physical scenes.

19. A non-transitory computer-readable storage medium storing instructions that, when executed by one or more processors of a communication device, cause the communication device to perform a method comprising:
receiving a first video stream comprising RGB data and a second video stream comprising grayscale mask data;
decoding the RGB data to obtain decoded RGB frame data;
decoding the grayscale mask data to obtain decoded alpha channel data;
synchronizing the decoded RGB frame data and the decoded alpha channel data based on presentation timestamps;
compositing the synchronized RGB frame data and the alpha channel data to generate blended RGBA output frames; and
displaying the blended RGBA output frames in real time on the communication device.

20. The non-transitory computer-readable storage medium of claim 19, wherein the instructions cause execution of a two-pass rendering process, wherein the two-pass rendering process comprises a first pass that processes the decoded RGB frame data and a second pass that applies the decoded alpha channel data to generate the blended RGBA output frames.
